(19) United States
(12) Patent Application Publication
(10) Pub. No.: US 2026/0299395 A1
(43) Pub. Date: Oct. 1, 2026

(54) FOLDING SUPPORT MEMBER AND FOLDING SCREEN

(71) Applicant: SEIKO EPSON CORPORATION, Tokyo (JP)

(72) Inventor: Ippei KUROTA, MATSUMOTO-SHI (JP)

(21) Appl. No.: 19/576,121

(22) Filed: Mar. 24, 2026

(30) Foreign Application Priority Data
Mar. 25, 2025 (JP) 2025-049488

(51) Int. Cl. G03B 21/58; F16M 11/08

(52) U.S. Cl. CPC G03B 21/58; F16M 11/08

(57) ABSTRACT

A folding support member that supports and unfolds a curtain includes a leg portion installed on an installation surface, a plurality of arms that support the curtain, and a support section that supports one end of each of the plurality of arms and one end of the leg portion, and a switching mechanism configured to switch between a stored state in which each of the plurality of arms and the leg portion extend from the support section along a first direction and an unfolded state in which the curtain is unfolded, wherein the unfolded state is a state in which another end of each of the plurality of arms and another end of the leg portion are separated from each other and each of the plurality of arms and the leg portion are unfolded.

The present application is based on, and claims priority from JP Application Serial Number 2025-049488, filed Mar. 25, 2025, the disclosure of which is hereby incorporated by reference herein in its entirety.

### BACKGROUND

### Technical Field

The present disclosure relates to a folding support member and a folding screen.

### Related Art

In the related art, a screen that displays an image projected from a projector is known. As such a screen, a foldable screen is known (for example, see JP-A-04-275538).

The folding screen described in JP-A-04-275538 includes four support arms to which four corners of the screen are fixed at tips, a slider to which an inner end of each support arm is rotatably attached, a pipe that slidably supports the slider, and a coupling arm that couples each support arm and one end of the pipe. In the folding screen, by pushing the slider into the tip of the pipe, the four support arms are expanded and the screen is expanded. On the other hand, the screen is stored by being slid in a direction opposite to the tip of the slider pipe.

JP-A-04-275538 is an example of the related art.

However, when the folding screen described in JP-A-04-275538 is used, the folding screen is disposed on the installation surface so that the lower end of the screen and the other end of the pipe are in contact with the installation surface. For this reason, there is a problem that the position of the screen is likely to be low and installability is low, and thus convenience is low.

Therefore, there has been a demand for a folding support member that can unfold a curtain such as a screen and has high convenience.

### SUMMARY

A folding support member according to a first aspect of the present disclosure is a folding support member that supports and unfolds a curtain including a leg portion installed on an installation surface, a plurality of arms that support the curtain, and a support section that supports one end of each of the plurality of arms and one end of the leg portion, and a switching mechanism configured to switch between a stored state in which each of the plurality of arms and the leg portion extend from the support section along a first direction and an unfolded state in which the curtain is unfolded, wherein the unfolded state is a state in which another end of each of the plurality of arms and another end of the leg portion are separated from each other and each of the plurality of arms and the leg portion are unfolded.

A folding screen according to a second aspect of the present disclosure includes the folding support member according to the first aspect, and a curtain supported by the folding support member, wherein the curtain is a screen that displays an image corresponding to a projected image light.

### BRIEF DESCRIPTION OF THE DRAWINGS

FIG. 1 is a perspective view showing a folding screen in an unfolded state in a first embodiment.

FIG. 2 is a perspective view showing the folding screen in an intermediate state in the first embodiment.

FIG. 3 is a perspective view showing the folding screen in a stored state in the first embodiment.

FIG. 4 is a perspective view showing a switching mechanism in the first embodiment.

FIG. 5 is a perspective view showing the switching mechanism in the first embodiment.

FIG. 6 is a perspective view showing the switching mechanism in the first embodiment.

FIG. 7 shows an arm in the stored state in the first embodiment.

FIG. 8 shows the arm in the intermediate state in the first embodiment.

FIG. 9 shows the arm in the unfolded state in the first embodiment.

FIG. 10 shows an intersection angle between an extension direction of a holding portion and the screen in the unfolded state in the first embodiment.

FIG. 11 shows a leg portion in the storage state in the first embodiment.

FIG. 12 shows the leg portion in the intermediate state in the first embodiment.

FIG. 13 shows the leg portion in the unfolded state in the first embodiment.

FIG. 14 is a perspective view showing a folding screen in a second embodiment.

FIG. 15 shows a leg portion in a storage state in the second embodiment.

FIG. 16 shows the leg portion in an intermediate state in the second embodiment.

FIG. 17 shows the leg portion in an unfolded state in the second embodiment.

### DESCRIPTION OF EMBODIMENTS

### First Embodiment

A first embodiment of the present disclosure will hereinafter be described with reference to the drawings.

### Schematic Configuration of Folding Screen

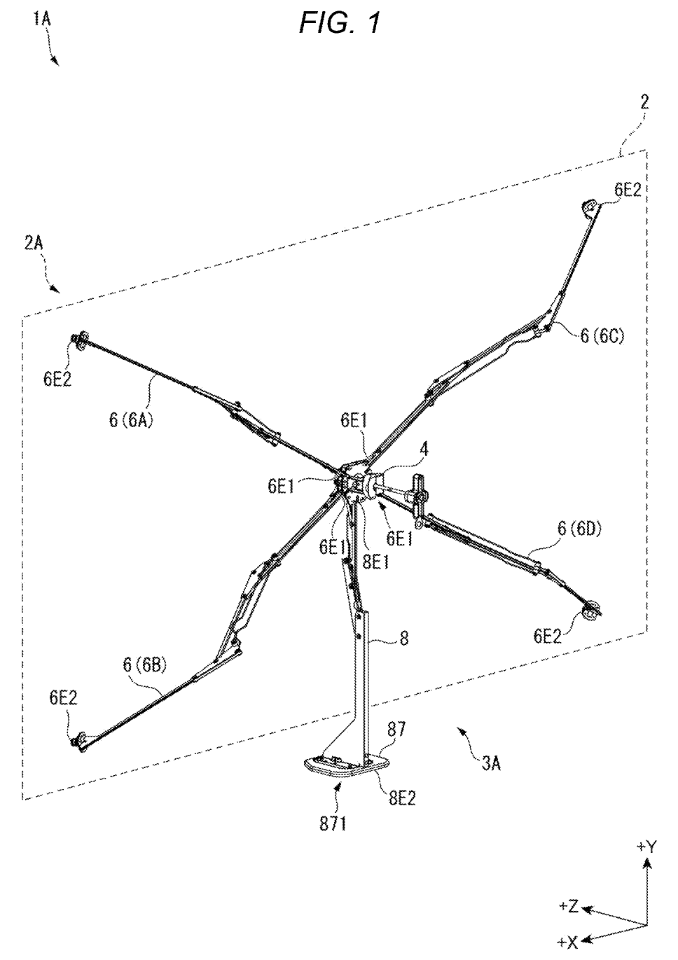

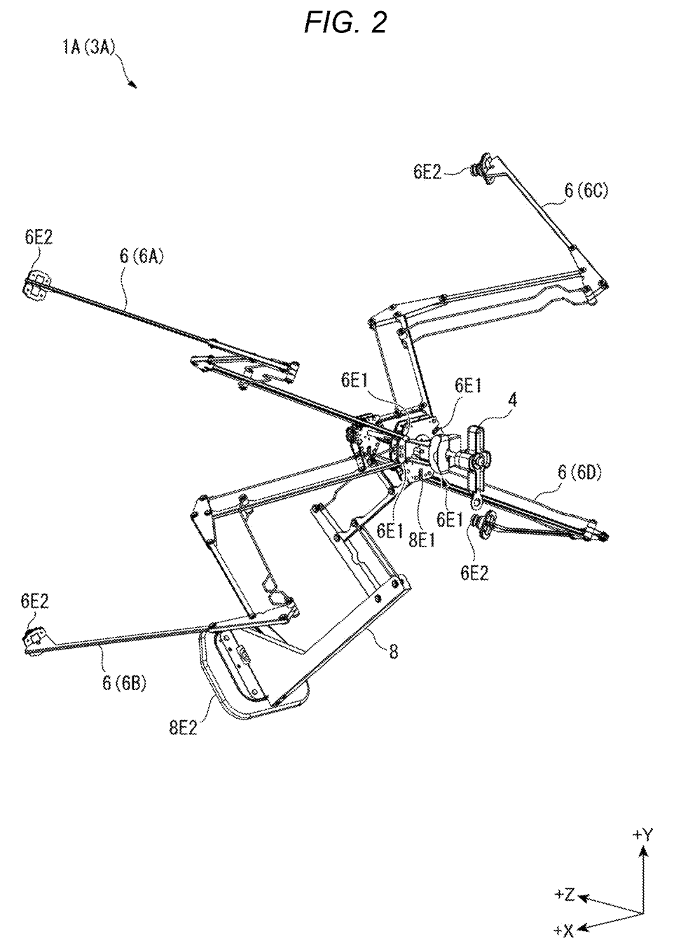

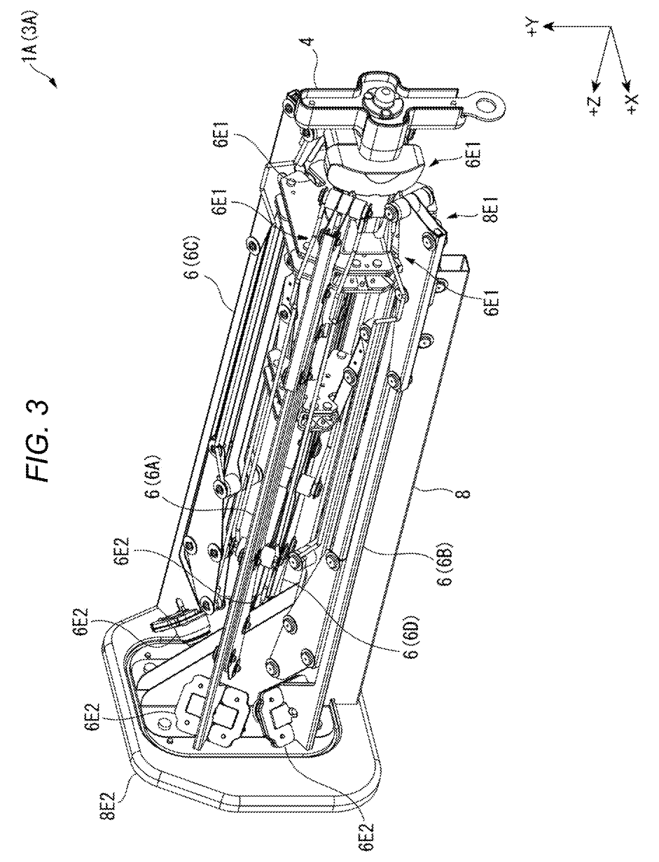

FIGS. 1 to 3 are perspective views showing a folding screen 1A according to the present embodiment. Specifically, FIG. 1 is a perspective view showing the folding screen 1A in an unfolded state. FIG. 2 is a perspective view showing the folding screen 1A in an intermediate state. FIG. 3 is a perspective view showing the folding screen 1A in a stored state.

A folding screen 1A according to the present embodiment includes a screen 2 illustrated in FIG. 1 and a folding support member 3A illustrated in FIGS. 1 to 3, and is configured to be switchable between the unfolded state illustrated in FIG. 1 and the stored state illustrated in FIG. 3 via the intermediate state illustrated in FIG. 2.

The stored state is a state in which a plurality of arms 6 and a leg portion 8 forming the folding support member 3A are folded and stored, and each of the plurality of arms 6 and the leg portion 8 extend along a +Z direction from a support section 41, which will be described later. That is, the stored state is a state in which one end portion 6E1 in each arm 6 and one end portion 8E1 in the leg portion 8 are close to each other, and the other end portion 6E2 in each arm 6 and the other end portion 8E2 in the leg portion 8 are close to each other.

The unfolded state is a state in which the screen 2, which is a curtain, is unfolded by the plurality of arms 6 and the leg portion 8 and the screen 2 can be used. Specifically, the unfolded state is a state in which the plurality of arms 6 and the leg portion 8 of the folding support member 3A are unfolded and the screen 2 is unfolded by the plurality of arms 6. That is, the unfolded state is a state in which the end portion 6E1 of each arm 6 and the end portion 8E1 of the leg portion 8 are close to each other, the end portion 6E2 of each arm 6 and the end portion 8E2 of the leg portion 8 are separated from each other, and each of the plurality of arms 6 and the leg portion 8 is unfolded. Specifically, the unfolded state is a state in which each end portion 6E1 is at the same position as each end portion 6E1 in the stored state, the end portion 8E1 is at the same position as the end portion 8E1 in the stored state, and each end portion 6E2 and the end portion 8E2 are separated from each other by a greater distance than each end portion 6E2 and the end portion 8E2 in the stored state. In other words, the unfolded state is a state in which the end portion 6E2 of each of the plurality of arms 6 and the end portion 8E2 of the leg portion 8 are moved to positions separated from each other, and the screen 2 is unfolded and can be installed on the installation surface.

The intermediate state is a state intermediate between the stored state and the unfolded state.

Hereinafter, each configuration of the folding screen 1A will be described. In the following description, the folding support member may be abbreviated as a support member.

### Configuration of Screen

As shown in FIG. 3, the screen 2 is a curtain unfolded by the support member 3A, and displays an image corresponding to image light projected from a projector (not illustrated). The screen 2 is a rectangular screen containing urethane resin and having elasticity.

Each of the four corner portions in the screen 2 is supported by the corresponding arm 6 among the plurality of arms 6, and the screen 2 is stored or unfolded according to the unfolded state of the plurality of arms 6.

In the present embodiment, the screen 2 is a reflective screen that reflects the image light projected from the projector and displays an image corresponding to the image light, and the surface opposite to the support member 3A in the screen 2 is a display surface 2A that displays the image corresponding to the image light. However, the screen 2 is not limited thereto, and may be a transmissive screen that transmits image light.

In the following description, three directions orthogonal to one another are referred to as a +X direction, a +Y direction, and the +Z direction. In the present embodiment, the +X direction is a direction along the longitudinal direction of the screen 2 in the unfolded state, the +Y direction is a direction along the lateral direction of the screen 2 in the unfolded state, and the +Z direction is a direction perpendicular to the screen 2 in the unfolded state. More specifically, the +Z direction is a direction perpendicular to the display surface 2A of the screen 2 in the unfolded state, the +Y direction is an upward direction along the lateral direction of the screen 2 when viewed from the +Z direction, and the +X direction is a rightward direction along the longitudinal direction of the screen 2 when viewed from the +Z direction.

Although not illustrated in the drawings, the direction opposite to the +Z direction is referred to as a -Z direction, the direction opposite to the +X direction is referred to as a -X direction, and the direction opposite to the +Y direction is referred to as a -Y direction.

### Configuration of Folding Support Member

The folding support member 3A supports the screen 2 as a curtain. As described above, the support member 3A is configured to be compactly stored by setting the state of the support member 3A to the stored state, and is configured to unfold the screen 2 by setting the state of the support member 3A to the unfolded state. As shown in FIGS. 1 to 3, the support member 3A includes a switching mechanism 4, the plurality of arms 6, and the leg portion 8.

### Configuration of Switching Mechanism

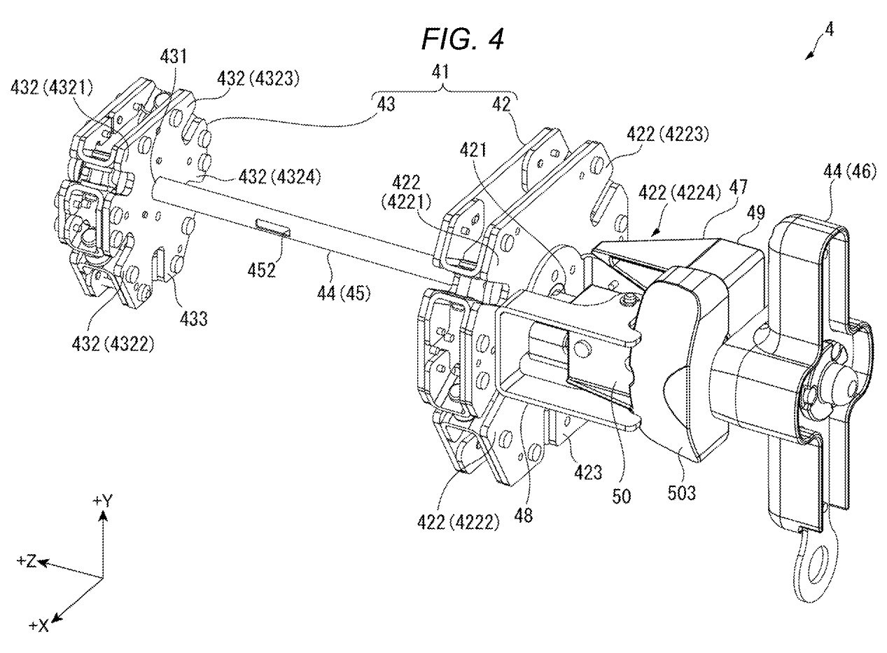

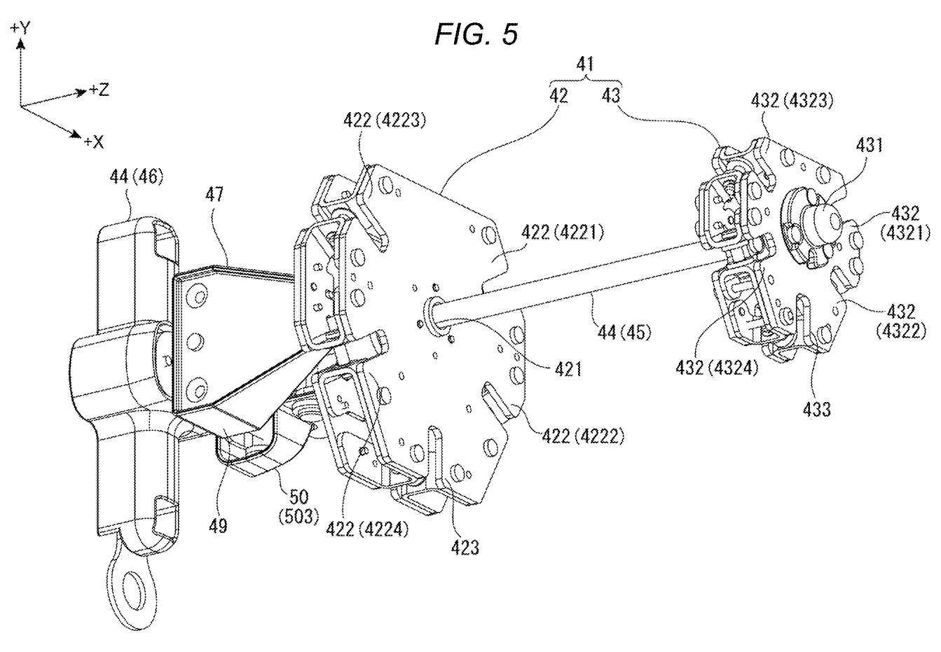

FIG. 4 is a perspective view showing the switching mechanism 4 viewed from the -Z direction, and FIG. 5 is a perspective view showing the switching mechanism 4 viewed from the +Z direction.

The switching mechanism 4 supports one end of each of the plurality of arms 6 and one end of the leg portion 8, and switches the state of the support member 3A between the stored state and the unfolded state in response to operation by a user. As shown in FIGS. 4 and 5, the switching mechanism 4 includes the support section 41 and a movement restriction section 47.

### Configuration of Support Section

The support section 41 rotatably supports one end of the arm 6 and the leg portion 8. Specifically, the support section 41 rotatably supports the end portion opposite to the end portion holding the screen 2 in the arm 6 and the end portion opposite to an installation base 87, which will be described later, in the leg portion 8. The support section 41 includes a notch 42 as a first support unit, a runner 43 as a second support unit, and a moving unit 44.

### Configuration of Notch

The notch 42 rotatably supports a first arm link 61, which will be described later, of each of the plurality of arms 6 about a rotation axis orthogonal to the +Z direction, and also rotatably supports a first leg link 81 of the leg portion 8 about a rotation axis orthogonal to the +Z direction. The movement restriction section 47 is fixed to the notch 42.

As illustrated in FIG. 5, the notch 42 includes a hole portion 421, an arm support portion 422, and a leg support portion 423.

The hole portion 421 is provided substantially at the center of the notch 42 when viewed from the +Z direction, and penetrates the notch 42 along the +Z direction. A shaft 45 of the moving unit 44 is inserted through the hole portion 421 along the +Z direction.

The arm support portion 422 is a portion that rotatably supports the first arm link 61 of each arm 6. The arm support portion 422 includes a first arm support portion 4221, a second arm support portion 4222, a third arm support portion 4223, and a fourth arm support portion 4224.

The first arm support portion 4221 rotatably supports the first arm link 61 of the first arm 6A. The second arm support portion 4222 rotatably supports the first arm link 61 of the second arm 6B. The third arm support portion 4223 rotatably supports the first arm link 61 of the third arm 6C. The fourth arm support portion 4224 rotatably supports the first arm link 61 of the fourth arm 6D.

The leg support portion 423 is disposed between the second arm support portion 4222 and the fourth arm support portion 4224 in the +X direction. The leg support portion 423 rotatably supports the first leg link 81 of the leg portion 8. The rotation axis of the first leg link 81 is along the +X direction.

### Configuration of Runner

The runner 43 is disposed in the +Z direction with respect to the notch 42. The runner 43 rotatably supports a fourth arm link 64, which will be described later, of each of the plurality of arms 6 about a rotation axis orthogonal to the +Z direction, and rotatably supports a fourth leg link 84 of the leg portion 8 about a rotation axis orthogonal to the +Z direction.

The runner 43 includes a coupling portion 431, an arm support portion 432, and a leg support portion 433.

The coupling portion 431 is coupled to an end portion of the shaft 45 of the moving unit 44 in the +Z direction. The coupling portion 431 is provided substantially at the center of the runner 43 when viewed from the +Z direction.

The arm support portion 432 is a portion that rotatably supports the fourth arm link 64 of each arm 6. The arm support portion 432 includes a first arm support portion 4321, a second arm support portion 4322, a third arm support portion 4323, and a fourth arm support portion 4324.

The first arm support portion 4321 rotatably supports the fourth arm link 64 of the first arm 6A. The second arm support portion 4322 rotatably supports the fourth arm link 64 of the second arm 6B. The third arm support portion 4323 rotatably supports the fourth arm link 64 of the third arm 6C. The fourth arm support portion 4324 rotatably supports the fourth arm link 64 of the fourth arm 6D.

The rotation axis of the fourth arm link 64 supported by the arm support portion 432 of the runner 43 is parallel to the rotation axis of the first arm link 61 of the same arm 6 as that of the fourth arm link 64. For example, among the plurality of arms 6, the rotation axis in the notch 42 of the first arm link 61 of the first arm 6A and the rotation axis in the runner 43 of the fourth arm link 64 of the first arm 6A are parallel to each other.

The leg support portion 433 is disposed between the second arm support portion 4322 and the fourth arm support portion 4324 in the +X direction. The leg support portion 433 rotatably supports the fourth leg link 84 of the leg portion 8. The rotation axis of the fourth leg link 84 is parallel to the rotation axis of the first leg link 81, and each rotation axis is along the +X direction.

### Configuration of Moving Unit

The moving unit 44 moves one of the notch 42 and the runner 43 in directions in which the one is moved closer to and away from the other. In the present embodiment, the moving unit 44 moves the runner 43 along the +Z direction closer to or away from the notch 42. The moving unit 44 includes the shaft 45 and a handle 46.

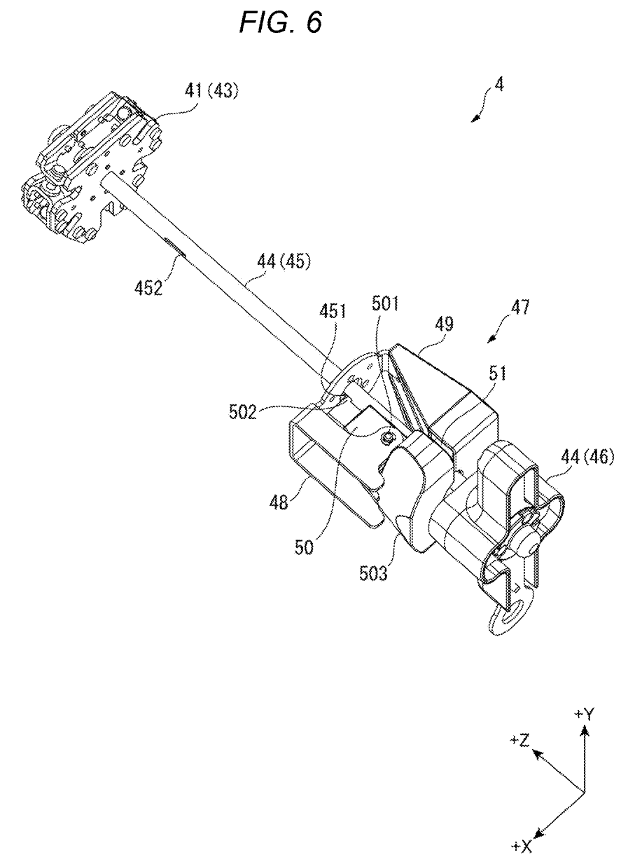

FIG. 6 is a perspective view showing the switching mechanism 4 in which the notch 42 is not illustrated.

The shaft 45 is a cylindrical rod-shaped member inserted through the hole portion 421 of the notch 42. An end portion in the shaft 45 in the +Z direction is coupled to the coupling portion 431 of the runner 43. As shown in FIG. 6, the shaft 45 has a first groove portion 451 and a second groove portion 452.

Each of the first groove portion 451 and the second groove portion 452 is a hole portion along the +Z direction.

The first groove portion 451 is provided at a position where the movement restriction section 47, which will be described later, can be engaged when the state of the support member 3A is the stored state. Specifically, the first groove portion 451 is provided at a position where the movement restriction section 47 can be inserted when the shaft 45 is moved most in the +Z direction and the state of the support member 3A is set to the stored state.

The second groove portion 452 is provided in the +Z direction with respect to the first groove portion 451. The second groove portion 452 is provided at a position where the movement restriction section 47 can be engaged when the state of the support member 3A is the unfolded state. Specifically, the second groove portion 452 is provided at a position where the movement restriction section 47 can be inserted when the shaft 45 is moved most in the -Z direction and the state of the support member 3A is set to the unfolded state.

The handle 46 is provided at an end portion in the shaft 45 in the -Z direction. Specifically, the handle 46 is provided at an end portion of the shaft 45 opposite to the runner 43 with respect to the notch 42. The handle 46 is gripped by the user when the shaft 45 is moved along the +Z direction to move the runner 43 closer to or away from the notch 42.

### Configuration of Movement Restriction Section

The movement restriction section 47 restricts the movement of the shaft 45 in the support member 3A in the stored state and the unfolded state, and thus restricts the movement of the runner 43 with respect to the notch 42 to restrict the movement of the arm 6 and the leg portion 8. The movement restriction section 47 includes a first holder 48, a second holder 49, a lock lever 50, and a biasing portion 51.

The first holder 48 and the second holder 49 are fixed to a surface facing the -Z direction in the notch 42.

The first holder 48 rotatably supports the lock lever 50. The first holder 48 is provided in the +X direction with respect to the shaft 45.

The second holder 49 is provided at the opposite side of the shaft 45 with respect to the first holder 48. That is, the second holder 49 is provided in the -X direction with respect to the shaft 45. The second holder 49 houses the biasing portion 51 inside.

The lock lever 50 is supported by the first holder 48 so as to be rotatable about a rotation axis along the +Y direction. The lock lever 50 includes a rotation support portion 501, a claw portion 502, and a release button 503.

The rotation support portion 501 is provided substantially at the center of the lock lever 50 when viewed from the +Y direction. The rotation support portion 501 is a portion supported by the first holder 48 so as to be rotatable about a rotation axis along the +Y direction.

The claw portion 502 is provided at an end portion in the lock lever 50 in the +Z direction. That is, the claw portion 502 is provided in the +Z direction with respect to the rotation support portion 501. The claw portion 502 is inserted into one of the first groove portion 451 and the second groove portion 452.

The release button 503 rotates the lock lever 50 in a direction in which the claw portion 502 is separated from the shaft. In a case where the claw portion 502 is inserted into the first groove portion 451 or the second groove portion 452, when the release button 503 is pressed in a direction closer to the shaft 45 by the user, the lock lever 50 rotates and the claw portion 502 is separated from the first groove portion 451 or the second groove portion 452. Accordingly, the lock of the shaft 45 by the claw portion 502 is released.

The biasing portion 51 is disposed in the second holder 49 and biases the lock lever 50 in a direction in which the claw portion 502 is closer to the shaft 45. Specifically, the biasing portion 51 biases the lock lever 50 clockwise when viewed from the +Y direction. In the present embodiment, the biasing portion 51 includes a compression coil spring, one end of the biasing portion 51 is fixed in the second holder 49, and the other end of the biasing portion 51 comes into contact with a portion in the -Z direction in the lock lever 50.

### Configuration of Arm

Each of the plurality of arms 6 has one end supported by the switching mechanism 4 and the other end supporting the corner portion of the screen 2. Each arm 6 is configured to be extendable and retractable, and extends and retracts according to the position of the runner 43 with respect to the notch 42. The plurality of arms 6 include the first arm 6A, the second arm 6B, the third arm 6C, and the fourth arm 6D.

The first arm 6A supports the corner portion in the +X direction and the +Y direction in the screen 2.

The second arm 6B supports the corner portion in the +X direction and the -Y direction in the screen 2.

The third arm 6C supports the corner portion in the -X direction and the +Y direction in the screen 2.

The fourth arm 6D supports the corner portion in the -X direction and the -Y direction in the screen 2.

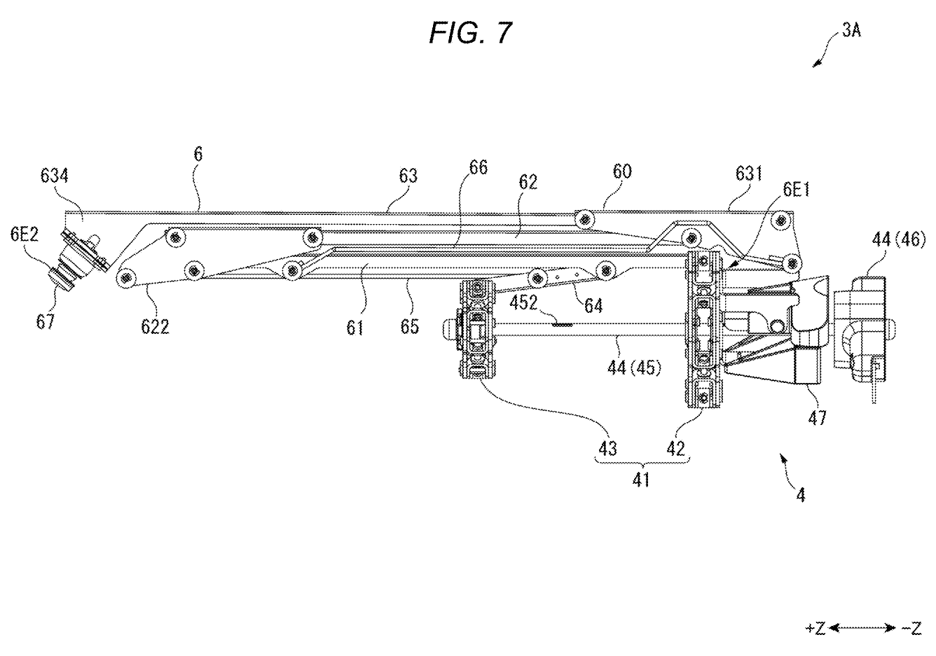

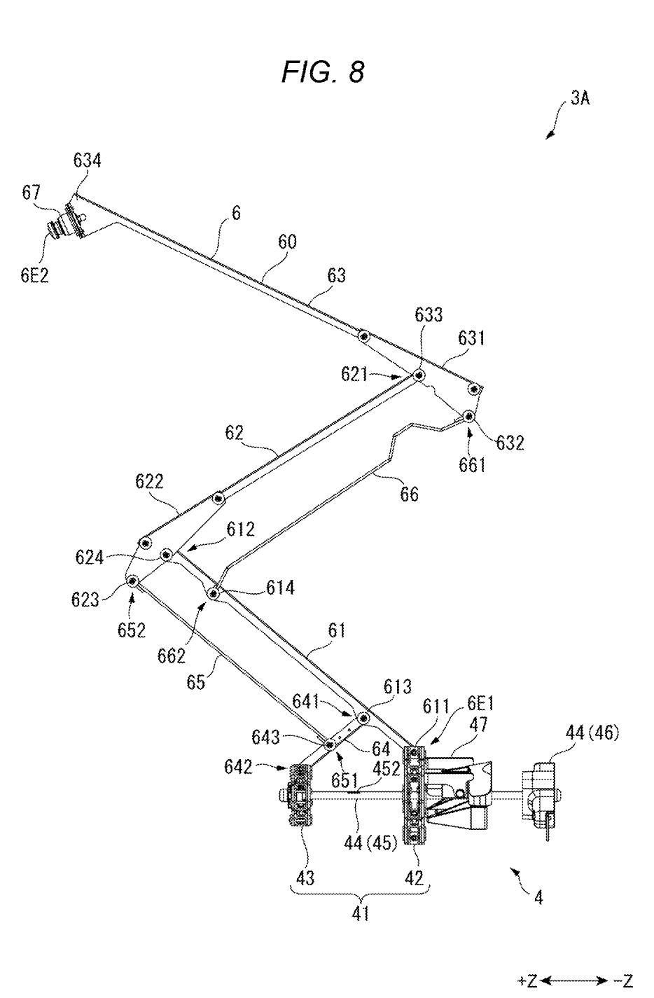

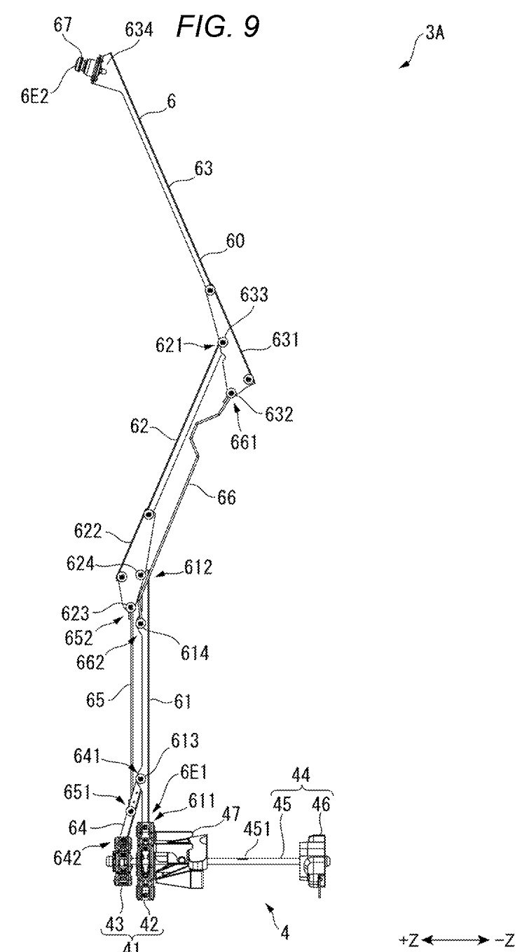

FIGS. 7 to 9 show one arm 6 among the plurality of arms 6. Specifically, FIG. 7 shows the arm 6 when the state of the support member 3A is the stored state. FIG. 8 shows the arm 6 when the state of the support member 3A is the intermediate state. FIG. 9 shows the arm 6 when the state of the support member 3A is the unfolded state.

As illustrated in FIGS. 7 to 9, each of the plurality of arms 6 includes the first arm link 61, a second arm link 62, a third arm link 63, the fourth arm link 64, a first arm wire 65, a second arm wire 66, and a holding portion 67. Of these components, the first arm link 61, the second arm link 62, and the third arm link 63 form an arm body 60 of each arm 6. That is, each arm 6 has the arm body 60 including the arm links 61 to 63. The above-described end portion 6E1 is also one end of the arm body 60, and the end portion 6E2 is also the other end of the arm body 60.

As shown in FIGS. 8 and 9, the first arm link 61 couples the notch 42 and the second arm link 62, and is coupled to the runner 43 via the fourth arm link 64. An end portion 611 in the -Z direction in the first arm link 61 is rotatably coupled to the notch 42, and an end portion 612 in the +Z direction is rotatably coupled to the second arm link 62. The end portion 611 forms the end portion 6E1 rotatably supported by the notch 42 of the support section 41 in the arm 6.

The first arm link 61 has coupling portions 613 and 614.

The coupling portion 613 is provided in a portion in the -Z direction between the end portion 611 and the end portion 612. An end portion 641 in the -Z direction in the fourth arm link 64 is rotatably coupled to the coupling portion 613.

The coupling portion 614 is provided in a portion in the +Z direction between the end portion 611 and the end portion 612. An end portion 662 of the second arm wire 66 is rotatably coupled to the coupling portion 614.

The second arm link 62 couples the first arm link 61 and the third arm link 63, and is also coupled to the fourth arm link 64 via the first arm wire 65. An end portion 621 in the -Z direction in the second arm link 62 is rotatably coupled to the third arm link 63. The second arm link 62 has a coupling portion 622 at an end portion in the +Z direction.

The coupling portion 622 is formed in a substantially rhombic shape. The coupling portion 622 includes a coupling portion 623 located at an end portion in the -Z direction and a coupling portion 624 located at an end portion at the first arm link 61 side.

An end portion 652 of the first arm wire 65 is rotatably coupled to the coupling portion 623. The end portion 612 of the first arm link 61 is rotatably coupled to the coupling portion 624.

The third arm link 63 is coupled to the second arm link 62 and the second arm wire 66, and holds one corner portion of the four corners of the screen 2. The third arm link 63 has a coupling portion 631 provided at an end portion in the -Z direction.

The coupling portion 631 is formed in a substantially right triangular shape having three corner portions, and is provided such that the two corner portions are provided at an end portion in the -Z direction in the third arm link 63 and the one corner portion is located in the +Z direction. The coupling portion 631 has coupling portions 632 and 633.

The coupling portion 632 is provided in the corner portion close to the switching mechanism 4 and the first arm link 61 among the two corner portions located in the -Z direction in the coupling portion 631. An end portion 661 of the second arm wire 66 is rotatably coupled to the coupling portion 632.

The coupling portion 633 is provided between the corner portion in the +Z direction and the coupling portion 632 in the coupling portion 631. The end portion 621 of the second arm link 62 is rotatably coupled to the coupling portion 633.

The holding portion 67 is provided at an end portion 634 in the +Z direction in the third arm link 63. The end portion 634 is the other end with respect to the coupling portion 632 as the one end in the third arm link 63.

The fourth arm link 64 is a con rod that couples the runner 43 and the first arm link 61 of the arm body 60. The end portion 641 in the -Z direction in the fourth arm link 64 is rotatably coupled to the coupling portion 613 of the first arm link 61. An end portion 642 in the +Z direction in the fourth arm link 64 is rotatably coupled to the runner 43.

The fourth arm link 64 has a coupling portion 643 located between the end portion 641 and the end portion 642. An end portion 651 of the first arm wire 65 is rotatably coupled to the coupling portion 643.

As described above, the first arm wire 65 couples the second arm link 62 and the fourth arm link 64. The end portion 651 in the -Z direction in the first arm wire 65 is rotatably coupled to the coupling portion 643 of the fourth arm link 64. The end portion 652 in the +Z direction in the first arm wire 65 is rotatably coupled to the coupling portion 623 of the second arm link 62.

The second arm wire 66 couples the first arm link 61 and the third arm link 63. The end portion 661 in the -Z direction in the second arm wire 66 is rotatably coupled to the coupling portion 632 of the third arm link 63. The end portion 662 in the +Z direction in the second arm wire 66 is rotatably coupled to the coupling portion 614 of the first arm link 61.

The holding portion 67 forms the end portion 6E2 of the arm 6. As described above, the holding portion 67 is provided at the end portion in the +Z direction in the third arm link 63 and holds the one corner in the screen 2. In the present embodiment, eyelet holes penetrating the screen 2 are provided in the four corners of the screen 2, and the holding portions 67 are inserted into the eyelet holes to hold the screen 2.

When the state of the support member 3A is the unfolded state, the holding portion 67 of each arm 6 is located in the +Z direction with respect to the switching mechanism 4. In other words, the end portion provided with the holding portion 67 in each arm 6 is disposed in the +Z direction with respect to the switching mechanism 4 when the state of the support member 3A is the unfolded state.

In the arm 6, the user pulls the handle 46 in the -Z direction in the stored state illustrated in FIG. 7 to bring the runner 43 coupled to the shaft 45 closer to the notch 42, and thus intersection angles between the arm links 61 to 64 and the arm wires 65 and 66 and the +Z direction increase in the intermediate state illustrated in FIG. 8. That is, each of the arm links 61 to 64 and arm wires 65 and 66 starts to extend along the +Y direction.

When the handle 46 is further pulled in the -Z direction and the runner 43 is disposed at a position closest to the notch 42, the intersection angles between the arm links 61 to 64 and arm wires 65 and 66 and the +Z direction further increase in the unfolded state illustrated in FIG. 9, and each of the arm links 61 to 64 and the arm wires 65 and 66 is disposed along the +Y direction. Accordingly, the screen 2 held by the holding portion 67 of each arm 6 is unfolded.

As described above, in the unfolded state, the claw portion 502 of the lock lever 50 is inserted into the second groove portion 452 of the shaft 45. As a result, the unfolded state is maintained.

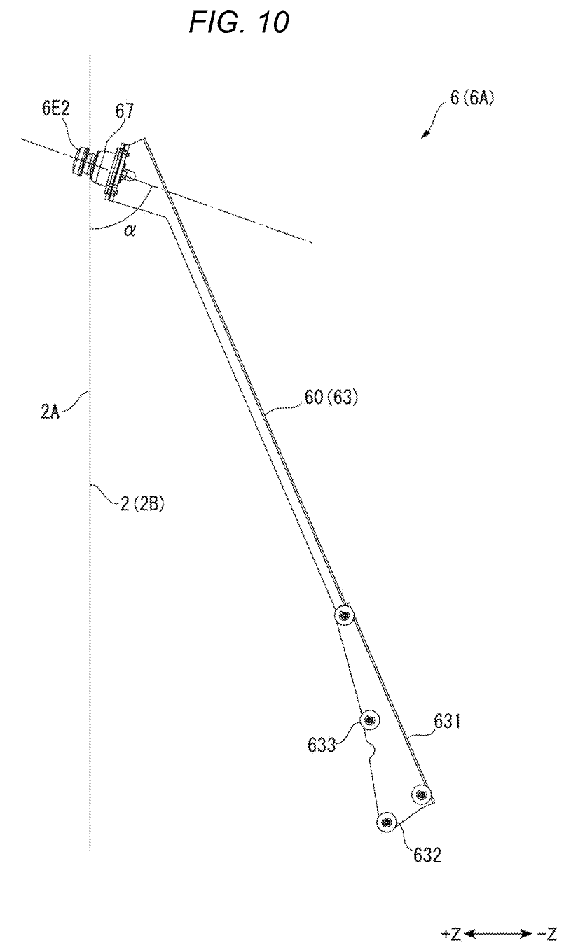

FIG. 10 shows the intersection angle between the extension direction of the holding portion 67 and the screen 2 in the unfolded state. Note that FIG. 10 shows the third arm link 63 of the first arm 6A, and the center of the screen 2 is located below in the view of FIG. 10.

Here, in the unfolded state in which the holding portion 67 and the screen 2 are unfolded, the intersection angle between the extension direction of the holding portion 67 and the screen 2 is a right angle or an acute angle at the center side of the screen 2. In the present embodiment, as illustrated in FIG. 10, in the unfolded state, an intersection angle α between the extension direction of the holding portion 67 and the screen 2 is an acute angle at the center side of the screen 2. Specifically, in the unfolded state, among intersection angles between the extension direction of the holding portion 67 and a rear surface 2B of the screen 2 at the switching mechanism 4 side, the intersection angle α facing the center of the screen 2 is an acute angle.

Accordingly, the inner edge of the eyelet hole at the side opposite to the center of the screen 2 is pressed toward the outside of the screen 2 by the holding portion 67. As a result, in the unfolded state, the four corners of the screen 2 are expanded to the outside of the screen 2 by the plurality of arms 6, and thus the screen 2 can be easily unfolded without wrinkles.

### Configuration of Leg Portion

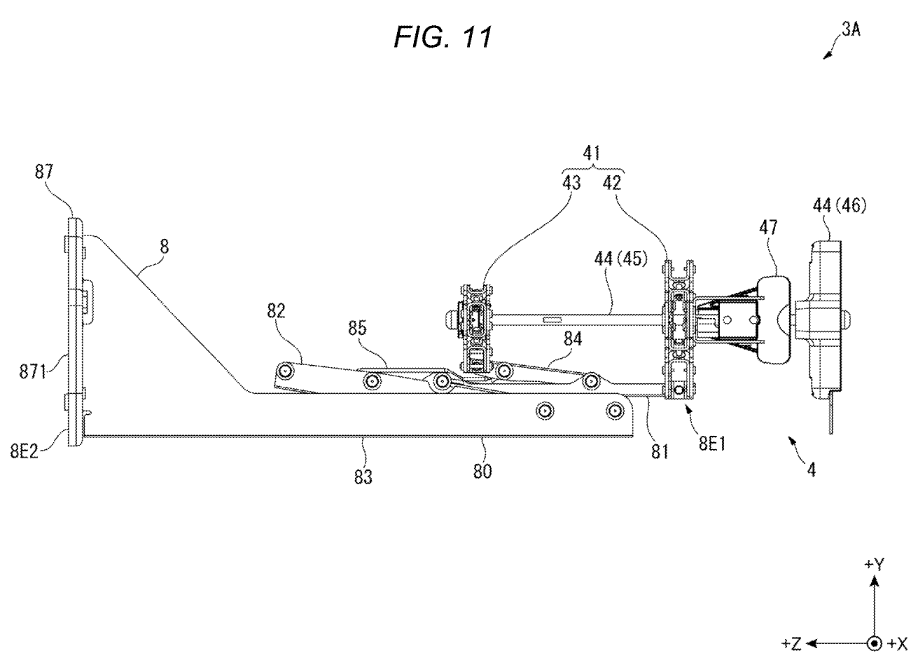

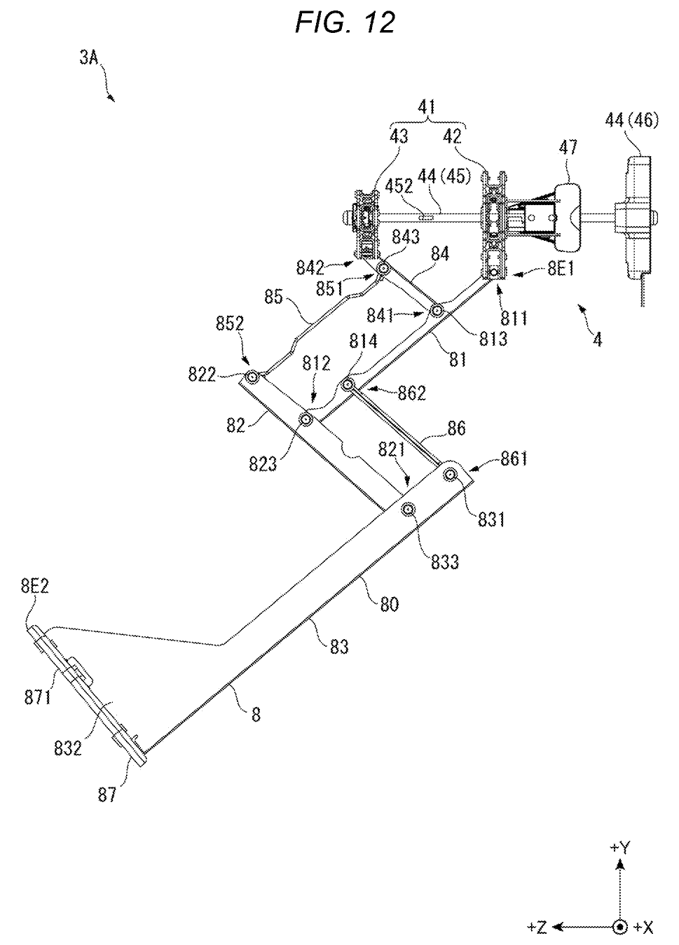

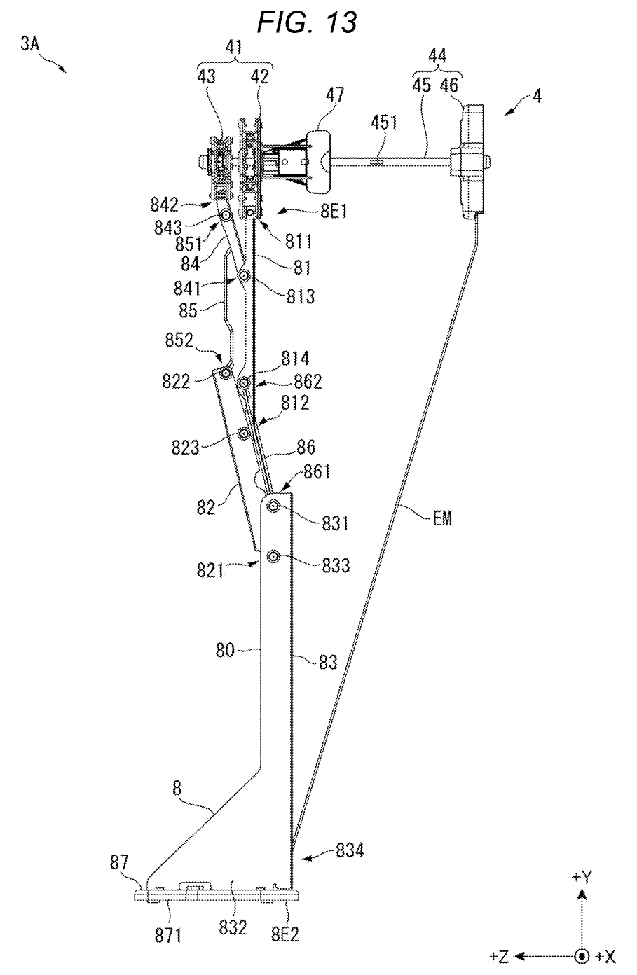

FIGS. 11 to 13 show the leg portion 8. Specifically, FIG. 11 shows the leg portion 8 when the state of the support member 3A is the stored state. FIG. 12 shows the leg portion 8 when the state of the support member 3A is the intermediate state. FIG. 13 shows the leg portion 8 when the state of the support member 3A is the unfolded state.

As described above, the leg portion 8 is a portion installed on the installation surface in the support member 3A, and is unfolded together with the plurality of arms 6 by the switching mechanism 4, and is also stored together with the plurality of arms 6.

As illustrated in FIGS. 11 to 13, the leg portion 8 includes the first leg link 81, the second leg link 82, the third leg link 83, the fourth leg link 84, the first leg wire 85, the second leg wire 86, and the installation base 87. Among these, the first leg link 81, the second leg link 82, and the third leg link 83 form a leg portion body 80 of the leg portion 8. That is, the leg portion 8 has the leg portion body 80 including the leg links 81 to 83. The end portion 8E1 described above is also one end of the leg portion body 80, and the end portion 8E2 is also the other end of the leg portion body 80.

The first leg link 81, the second leg link 82, the third leg link 83, the fourth leg link 84, the first leg wire 85, and the second leg wire 86 have the same configurations and functions as the first arm link 61, the second arm link 62, the third arm link 63, the fourth arm link 64, the first arm wire 65, and the second arm wire 66 provided in the arm 6.

As illustrated in FIGS. 12 and 13, the first leg link 81 couples the notch 42 and the second leg link 82, and is coupled to the runner 43 via the fourth leg link 84. An end portion 811 in the -Z direction in the first leg link 81 is rotatably coupled to the notch 42, and an end portion 812 in the +Z direction is rotatably coupled to the second leg link 82. The end portion 811 forms the end portion 8E1 rotatably supported by the notch 42 of the support section 41 in the leg portion 8.

The first leg link 81 has coupling portions 813 and 814.

The coupling portion 813 is provided in a portion in the -Z direction between the end portion 811 and the end portion 812. An end portion 841 in the -Z direction in the fourth leg link 84 is rotatably coupled to the coupling portion 813.

The coupling portion 814 is provided in a portion in the +Z direction between the end portion 811 and the end portion 812. An end portion 862 in the +Z direction in the second leg wire 86 is rotatably coupled to the coupling portion 814.

The second leg link 82 couples the first leg link 81 and the third leg link 83, and is also coupled to the fourth leg link 84 via the first leg wire 85. An end portion 821 in the -Z direction in the second leg link 82 is rotatably coupled to the third leg link 83. An end portion 852 of the first leg wire 85 is rotatably coupled to an end portion 822 in the +Z direction in the second leg link 82.

The second leg link 82 has a coupling portion 823 at a position closer to the end portion 822 between the end portion 821 and the end portion 822. The end portion 812 of the first leg link 81 is rotatably coupled to the coupling portion 823.

The third leg link 83 is coupled to the second leg link 82 and the second leg wire 86, and also forms the body of the leg portion 8 installed on the installation surface. An end portion 861 in the -Z direction in the second leg wire 86 is rotatably coupled to an end portion 831 in the -Z direction in the third leg link 83. The installation base 87 is fixed to an end portion 832 in the +Z direction in the third leg link 83.

The third leg link 83 has a coupling portion 833 at a position closer to the end portion 831 between the end portion 831 and the end portion 832. The end portion 821 of the second leg link 82 is rotatably coupled to the coupling portion 833.

As shown in FIG. 13, an elastic member EM of rubber or the like having one end coupled to the handle 46 can be attached to the third leg link 83. That is, the third leg link 83 has an attachment portion 834 to which the elastic member EM can be attached at a position near the end portion 832. The elastic member EM is attached to the handle 46 and the attachment portion 834, and thus a biasing force in the -Z direction acts on the runner 43, the shaft 45, and the handle 46. Accordingly, rattling of the notch 42, the runner 43, the arms 6, and the leg portion 8 can be suppressed.

The third leg link 83 may be configured to be extendable and retractable in a range from the coupling portion 833 to the end portion 832. In this case, the overall length of the leg portion 8 can be adjusted.

As shown in FIGS. 12 and 13, the fourth leg link 84 is a con rod that couples the runner 43 and the first leg link 81 of the leg portion body 80. The end portion 841 in the -Z direction in the fourth leg link 84 is rotatably coupled to the coupling portion 813 of the first leg link 81. An end portion 842 in the +Z direction in the fourth leg link 84 is rotatably coupled to the leg support portion 433 of the runner 43.

The fourth leg link 84 has a coupling portion 843 at a position closer to the end portion 842 between the end portion 841 and the end portion 842. An end portion 851 of the first leg wire 85 is rotatably coupled to the coupling portion 843.

The first leg wire 85 couples the second leg link 82 and the fourth leg link 84. The end portion 851 in the -Z direction in the first leg wire 85 is rotatably coupled to the coupling portion 843 of the fourth leg link 84. The end portion 852 in the +Z direction in the first leg wire 85 is rotatably coupled to the end portion 822 of the second leg link 82.

The second leg wire 86 couples the first leg link 81 and the third leg link 83. The end portion 861 in the -Z direction in the second leg wire 86 is rotatably coupled to the end portion 831 of the third leg link 83. The end portion 862 in the +Z direction in the second leg wire 86 is rotatably coupled to the coupling portion 814 of the first leg link 81.

As described above, the installation base 87 is provided at the end portion 832 in the +Z direction in the third leg link 83, and forms the end portion 8E2 in the leg portion 8. In other words, the installation base 87 is provided at the end portion 832 at the opposite side to the end portion to which the second leg link 82 and the second leg wire 86 are coupled in the third leg link 83. As shown in FIG. 1, the installation base 87 has a substantially rectangular contact surface 871 that contacts the installation surface. Although not illustrated, the installation base 87 is provided with a hole portion to which a tripod or the like can be attached.

In the leg portion 8 described above, the user pulls the handle 46 in the -Z direction in the stored state illustrated in FIG. 11 to bring the runner 43 coupled to the shaft 45 closer to the notch 42, and thus the intersection angles between the leg links 81 to 84 and leg wires 85 and 86 and the +Z direction increase in the intermediate state illustrated in FIG. 12. That is, each of the leg links 81 to 84 and the leg wires 85 and 86 starts to extend along the +Y direction.

When the handle 46 is further pulled in the -Z direction and the runner 43 is disposed at a position closest to the notch 42, the intersection angles between the leg links 81 to 84 and leg wires 85 and 86 and the +Z direction further increase in the unfolded state illustrated in FIG. 13, and each of the leg links 81 to 84 and the leg wires 85 and 86 is disposed along the +Y direction. In particular, the third leg link 83 is substantially parallel to the +Y direction, and the contact surface 871 of the installation base 87 is a surface orthogonal to the +Y direction.

As described above, by moving the shaft 45 provided with the handle 46 along the +Z direction and moving the runner 43 with respect to the notch 42, the plurality of arms 6 supporting the screen 2 and the leg portion 8 having the installation base 87 can be simultaneously unfolded and stored.

### Effects of First Embodiment

The folding screen 1A according to the present embodiment described above has the following effects.

The folding screen 1A includes the folding support member 3A and the screen 2 supported by the folding support member 3A. The screen 2 corresponds to a curtain and displays an image corresponding to the projected image light.

The folding support member 3A unfolds the supported screen 2. The folding support member 3A includes the switching mechanism 4, the plurality of arms 6, and the leg portion 8.

The leg portion 8 is installed on the installation surface. The plurality of arms 6 support the screen 2.

The switching mechanism 4 includes the support section 41 that supports the end portion 6E1 as one end of each of the plurality of arms 6 and the end portion 8E1 as one end of the leg portion 8. The switching mechanism 4 can switch between the stored state in which each of the plurality of arms 6 and the leg portion 8 extend from the support section 41 along the +Z direction and the unfolded state in which the screen 2 is unfolded. The +Z direction corresponds to a first direction.

The unfolded state is a state in which the end portion 6E2 as the other end of each of the plurality of arms 6, and the end portion 8E2 as the other end of the leg portion 8 separated from each other and each of the plurality of arms 6 and the leg portion 8 is unfolded.

According to the configuration, by switching the state of the support member 3A from the stored state to the unfolded state by the switching mechanism 4, the screen 2 can be used, and the leg portion 8 can be installed on the installation surface. Accordingly, it is possible to prevent the screen 2 from coming into contact with the installation surface, and it is not necessary to separately support the support member 3A by a jig. Therefore, the installability of the support member 3A can be enhanced, and the convenience of the support member 3A can be enhanced.

In the support member 3A, the support section 41 includes the notch 42 as the first support unit, the runner 43 as the second support unit, and the moving unit 44.

The moving unit 44 moves one of the notch 42 and the runner 43 toward and away from the other along the +Z direction. In the present embodiment, the moving unit 44 moves the runner 43 toward and away from the notch 42 along the +Z direction.

Each of the plurality of arms 6 has the first arm link 61, the second arm link 62, the third arm link 63, the fourth arm link 64, and the holding portion 67.

The first arm link 61 has the portion at the end portion 6E1 side rotatably supported by the notch 42. In the present embodiment, the end portion 611 of the first arm link 61 is rotatably supported by the notch 42.

The portion at the other end side of the first arm link 61 is rotatably coupled to the second arm link 62. In the present embodiment, the end portion 612 of the first arm link 61 is rotatably coupled to the coupling portion 624 of the second arm link 62.

The portion at the end portion 6E2 side of the second arm link 62 is rotatably coupled to the third arm link 63. In the present embodiment, the end portion 621 of the second arm link 62 is rotatably coupled to the coupling portion 633 of the third arm link 63.

The fourth arm link 64 has the portion at the end portion 6E1 side rotatably coupled to the runner 43. The portion at the end portion 6E2 side of the fourth arm link 64 is rotatably coupled between the end portion 611 of the first arm link 61 and the end portion 612 of the first arm link 61. In the present embodiment, the end portion 642 as the other end of the fourth arm link 64 is rotatably coupled to the runner 43, and the end portion 641 as one end thereof is rotatably coupled to the coupling portion 613 provided between the end portion 611 and the end portion 612 in the first arm link 61.

The holding portion 67 is provided at an end portion 634 as the other end of the third arm link 63. The holding portion 67 holds the screen 2.

According to the configuration, it is possible to easily switch between the stored state and the unfolded state by moving one of the notch 42 and the runner 43 toward and away from the other by the moving unit 44. In the present embodiment, the stored state and the unfolded state can be switched by moving the runner 43 toward and away from the notch 42 by the moving unit 44.

In addition, each of the plurality of arms 6 has the above-described configuration, and thus it is possible to reduce the size of the support member 3A in the stored state and to unfold the large screen 2 in the unfolded state.

Therefore, the convenience of the support member 3A can be enhanced.

In the support member 3A, the intersection angle between the extension direction of the holding portion 67 and the screen 2 in the unfolded state is a right angle or an acute angle at the center side of the screen 2. In the present embodiment, as illustrated in FIG. 10, the intersection angle α between the extension direction of the holding portion 67 and the screen 2 in the unfolded state is an acute angle at the center side of the screen 2.

According to the configuration, the plurality of arms 6 can apply biasing forces in directions away from the center of the screen 2 to the corner portions of the screen 2 in the unfolded state. Therefore, the screen 2 can be unfolded without wrinkles.

In the support member 3A, at least one of the first arm link 61 and the second arm link 62 is replaceable. In the present embodiment, each of the arm links 61 and 62 is replaceable.

According to the configuration, the length of the arm 6 can be adjusted according to the size of the screen 2 to be unfolded by replacing at least one of the first arm link 61 and the second arm link 62. That is, by adjusting the lengths of the arms 6, the screens 2 having different sizes can be unfolded. Therefore, the convenience of the support member 3A can be enhanced.

In the support member 3A, the moving unit 44 includes the shaft 45 and the handle 46.

The shaft 45 extends along the +Z direction, and is inserted through one of the notch 42 and the runner 43 and coupled to the other. In the present embodiment, the shaft 45 is inserted through the notch 42 and coupled to the runner 43.

The handle 46 is provided at the side opposite to the runner 43 with respect to the notch 42 in the shaft 45.

According to the configuration, the runner 43 can be moved toward and away from the notch 42 by gripping the handle 46 and moving the shaft 45 along the +Z direction. Accordingly, the state of the support member 3A can be easily switched between the stored state and the unfolded state. Therefore, the convenience of the support member 3A can be enhanced.

In the support member 3A, the shaft 45 is inserted through the notch 42 and coupled to the runner 43. The handle 46 is provided at the end portion opposite to the runner 43 with respect to the notch 42 in the shaft 45.

According to the configuration, the handle 46 is disposed in the direction opposite to the +Z direction in which the plurality of arms 6 extend from the support section 41 in the stored state with respect to the notch 42. Accordingly, the screen 2 can be unfolded by pulling the handle 46 in the -Z direction opposite to the +Z direction. Therefore, since the screen 2 can be easily unfolded as compared with a case where the handle 46 is located at the runner 43 side with respect to the notch 42, the convenience of the support member 3A can be enhanced.

In the support member 3A, the shaft 45 has the first groove portion 451 and the second groove portion 452 separated from each other along the +Z direction. The switching mechanism 4 includes the movement restriction section 47 that is inserted into the first groove portion 451 in the stored state and is inserted into the second groove portion 452 in the unfolded state to restrict the movement of the shaft 45 along the +Z direction.

According to the configuration, the movement of the shaft 45 can be respectively restricted when the state of the support member 3A is the stored state and the unfolded state. In other words, it is possible to restrict the easy movement of the plurality of arms 6 and the leg portion 8 in each of the stored state and the unfolded state. Therefore, the state of the support member 3A can be easily maintained in the stored state and the unfolded state.

In the support member 3A, the movement restriction section 47 includes the claw portion 502 that can be inserted into the first groove portion 451 and the second groove portion 452, and the biasing portion 51 that biases the claw portion 502 in the direction in which the claw portion 502 is inserted into the shaft 45. Specifically, the claw portion 502 is provided on the lock lever 50, and the lock lever 50 is biased by the biasing portion 51 in the direction in which the claw portion 502 is closer to the shaft 45.

According to the configuration, the claw portion 502 can be easily inserted into the first groove portion 451 or the second groove portion 452. Therefore, the state of the support member 3A can be easily maintained in the stored state and the unfolded state.

In the support member 3A, the switching mechanism 4 includes the movement restriction section 47 that restricts the movement of the runner 43 along the +Z direction in one of the stored state and the unfolded state.

According to the configuration, similarly to the above, the state of the support member 3A can be easily maintained in the stored state and the unfolded state by the movement restriction section 47.

In the support member 3A, the leg portion 8 has the first leg link 81, the second leg link 82, the third leg link 83, the fourth leg link 84, and the installation base 87.

The first leg link 81 has the portion at the end portion 8E1 side rotatably supported by the notch 42. Specifically, the end portion 811 of the first leg link 81 is rotatably supported by the leg support portion 423 of the notch 42.

The second leg link 82 has the portion at the end portion 8E1 side rotatably coupled to the portion at the end portion 8E2 side of the first leg link 81. Specifically, the coupling portion 823 located at the end portion 822 side in the +Z direction in the second leg link 82 is rotatably coupled to the end portion 812 of the first leg link 81.

The third leg link 83 has the portion at the end portion 8E1 side rotatably coupled to the portion at the end portion 8E2 side of the second leg link 82. Specifically, the coupling portion 833 located at the end portion 831 side in the -Z direction of the third leg link 83 is rotatably coupled to the end portion 821 in the -Z direction side of the second leg link 82.

The fourth leg link 84 has the portion at the end portion 8E1 side rotatably coupled between the end portion 811 and the end portion 812 of the first leg link 81 and the portion at the end portion 8E2 side rotatably coupled to the runner 43. Specifically, the end portion 841 of the fourth leg link 84 is rotatably coupled to the coupling portion 813 of the first leg link 81, and the end portion 842 of the fourth leg link 84 is rotatably coupled to the runner 43.

The installation base 87 is provided at the end portion 832 as the other end of the third leg link 83. The installation base 87 is installed on the installation surface.

According to the configuration, when the state of the support member 3A is changed from the stored state to the unfolded state, the leg portion 8 can be easily unfolded together with the unfolding of the screen 2.

Furthermore, in the leg portion 8, the leg links 81 to 84 are folded in the stored state, and thus the leg portion 8 can be compactly stored in the stored state even when the longer leg portion 8 is employed. In other words, since the longer leg portion 8 can be adopted, the distance between the unfolded screen 2 and the installation surface can be increased. Therefore, the screen 2 can be unfolded in a place apart from the installation surface, and thus the convenience of the support member 3A can be enhanced.

In the support member 3A, the end portion 6E2 of each of the plurality of arms 6 is disposed in the +Z direction with respect to the switching mechanism 4 in the unfolded state.

According to the configuration, it is possible to prevent the unfolded screen 2 from interfering with the switching mechanism 4. Therefore, the screen 2 can be unfolded without wrinkles.

### Second Embodiment

A second embodiment of the present disclosure will now be described.

The folding screen according to the present embodiment has the same configuration as the folding screen 1A according to the first embodiment, but the configuration of the leg portion is different. Note that in the following description, the same or substantially the same portions as the portions already described have the same signs, and the description thereof will be omitted.

### Schematic Configuration of Folding Screen

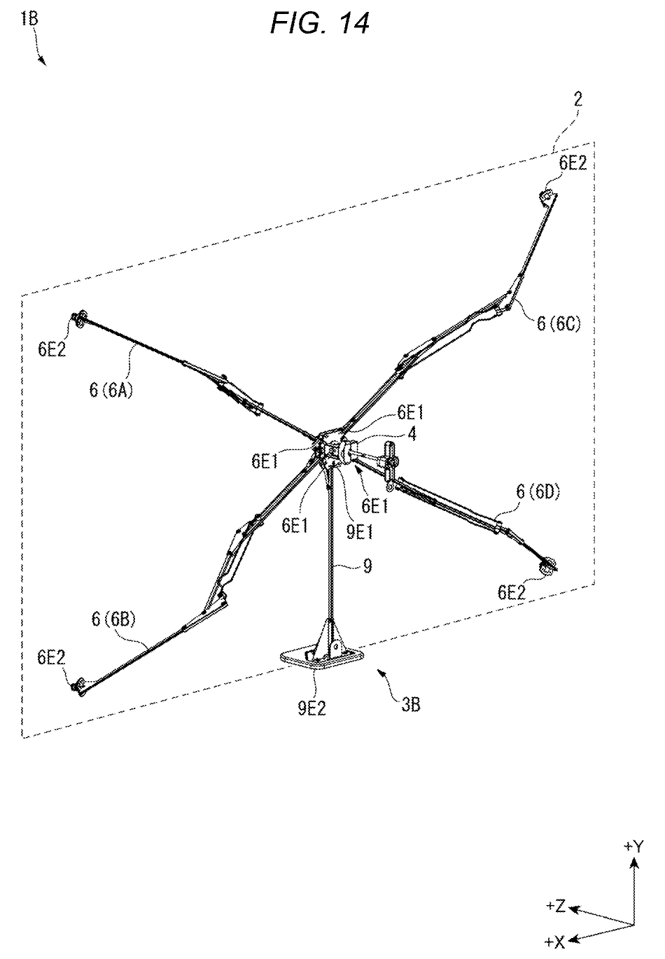

FIG. 14 is a perspective view showing a folding screen 1B according to the present embodiment.

As illustrated in FIG. 14, the folding screen 1B according to the present embodiment has the same configuration and function as those of the folding screen 1A according to the first embodiment except that a folding support member 3B is provided instead of the folding support member 3A.

The folding support member 3B has the same configuration and function as those of the folding support member 3A according to the first embodiment except that a leg portion 9 is provided instead of the leg portion 8. That is, the folding support member 3B includes the switching mechanism 4, the plurality of arms 6, and the leg portion 9.

### Configuration of Leg Portion

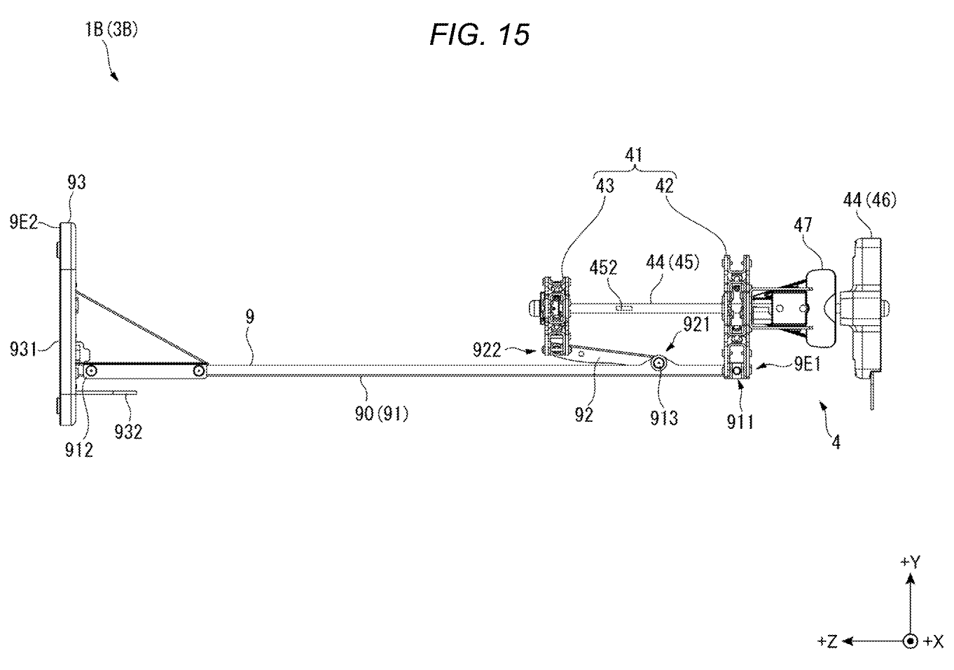

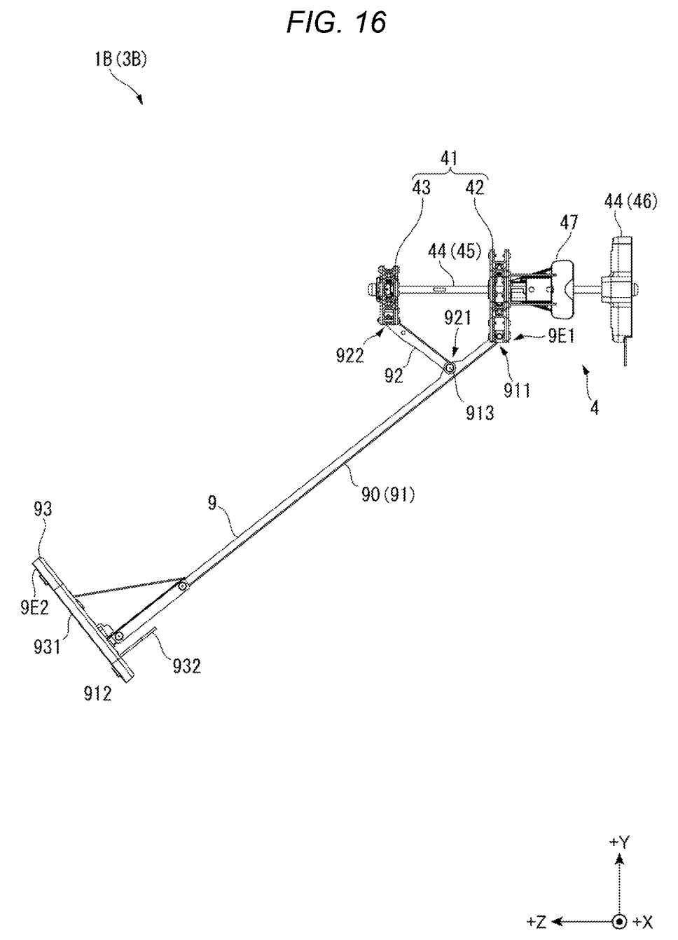

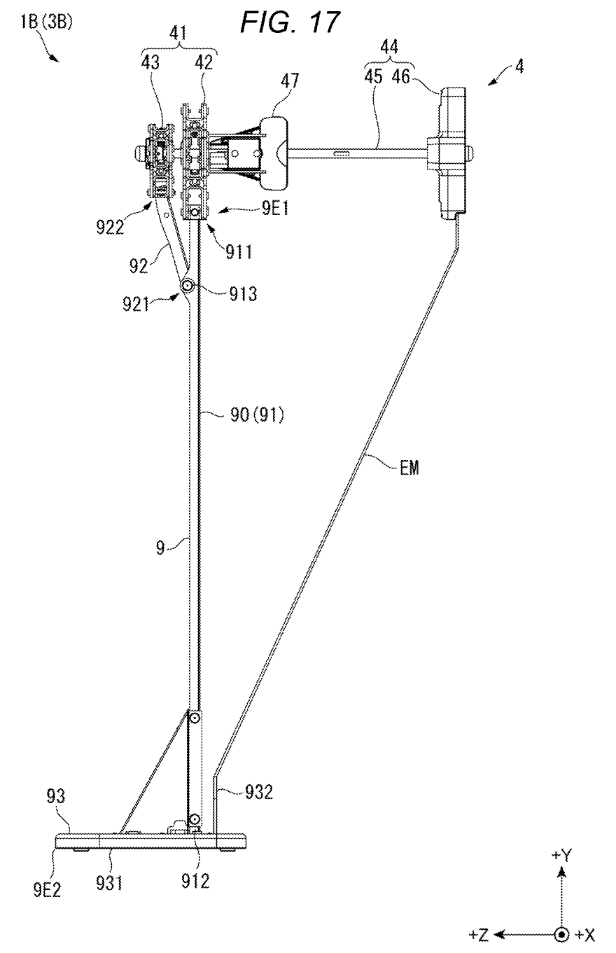

FIGS. 15 to 17 show the leg portion 9. Specifically, FIG. 15 shows the leg portion 9 when the state of the support member 3B is the stored state. FIG. 16 shows the leg portion 9 when the state of the support member 3B is the intermediate state. FIG. 17 shows the leg portion 9 when the state of the support member 3B is the unfolded state.

As described above, the leg portion 9 is a portion installed on the installation surface in the support member 3B, and is unfolded together with the plurality of arms 6 by the switching mechanism 4, and is stored together with the plurality of arms 6. As illustrated in FIGS. 15 to 17, the leg portion 9 includes a first leg link 91, a second leg link 92, and an installation base 93. The first leg link 91 forms a leg portion body 90 of the leg portion 9. That is, the leg portion 9 has the leg portion body 90 including the first leg link 91. An end portion 9E1 as one end of the leg portion 9 is also one end of the leg portion body 90, and an end portion 9E2 as the other end of the leg portion 9 is also the other end of the leg portion body 90.

In the present embodiment, the stored state is a state in which the plurality of arms 6 and the leg portion 9 forming the folding support member 3B are folded and stored, and each of the plurality of arms 6 and the leg portion 9 extend from the support section 41 along the +Z direction. That is, the stored state is a state in which the end portion 6E1 of each arm 6 and the one end portion 9E1 in the leg portion 9 are close to each other, and the end portion 6E2 of each arm 6 and the other end portion 9E2 in the leg portion 9 are close to each other.

The unfolded state is a state in which the screen 2, which is a curtain, is unfolded by the plurality of arms 6 and the leg portion 9 and the screen 2 can be used. Specifically, the unfolded state is a state in which the plurality of arms 6 and the leg portion 9 are unfolded and the screen 2 is unfolded by the plurality of arms 6. That is, the unfolded state is a state in which the end portion 6E1 of each arm 6 and the end portion 9E1 of the leg portion 9 are close to each other, the end portion 6E2 of each arm 6 and the end portion 9E2 of the leg portion 9 are separated from each other, and each of the plurality of arms 6 and the leg portion 9 are unfolded. In other words, the unfolded state is a state in which the end portion 6E2 of each of the plurality of arms 6 and the end portion 9E2 of the leg portion 9 are moved to positions separated from each other, and the screen 2 is unfolded and can be installed on the installation surface.

The first leg link 91 has an end portion 911 located in the -Z direction, an end portion 912 located in the +Z direction, and a coupling portion 913 when the support member 3B is in the stored state.

The end portion 911 forms the end portion 9E1. The end portion 911 is supported by the leg support portion 423 of the notch 42 forming the support section 41 so as to be rotatable about a rotation axis along the +X direction.

The installation base 93 is fixed to the end portion 912.

The coupling portion 913 is provided at a position at the end portion 911 side between the end portion 911 and the end portion 912. An end portion 921 of the second leg link 92 is coupled to the coupling portion 913 so as to be rotatable about a rotation axis along the +X direction.

A portion between the coupling portion 913 in the first leg link 91 and the end portion 912 may be configured to be extendable and retractable.

The second leg link 92 is a con rod that couples the runner 43 and the first leg link 91 of the leg portion body 90. The second leg link 92 has the end portion 921 located in the -Z direction and an end portion 922 located in the +Z direction when the support member 3B is in the stored state.

The end portion 921 is coupled to the coupling portion 913 of the first leg link 91.

The end portion 922 is supported by the leg support portion 433 of the runner 43 so as to be rotatable about a rotation axis along the +X direction.

The installation base 93 forms the end portion 9E2 as the other end of the leg portion 9. The installation base 93 is a portion that is provided at the end portion 912 of the first leg link 91 and can be installed on the installation surface when the state of the support member 3B is the unfolded state. As shown in FIG. 14, the installation base 93 has a substantially rectangular contact surface 931 that contacts the installation surface.

As illustrated in FIG. 17, the installation base 93 has an attachment portion 932 that protrudes from a surface opposite to the contact surface 931, to which the other end of the elastic member EM having one end attached to the handle 46 is attached.

Although not illustrated, the installation base 93 is provided with a hole to which a tripod or the like can be attached.

In the leg portion 9, the user pulls the handle 46 in the -Z direction in the stored state illustrated in FIG. 15 to bring the runner 43 coupled to the shaft 45 closer to the notch 42, and thus the intersection angles between the leg links 91 and 92 and the +Z direction increase in the intermediate state illustrated in FIG. 16. That is, each of the leg links 91 and 92 starts to extend along the +Y direction.

When the handle 46 is further pulled in the -Z direction and the runner 43 is disposed at a position closest to the notch 42, the intersection angles between the leg links 91 and 92 and the +Z direction further increase in the unfolded state illustrated in FIG. 17, and each of the leg links 91 and 92 is disposed along the +Y direction. In particular, the first leg link 91 is substantially parallel to the +Y direction, and the contact surface 931 of the installation base 93 is a surface orthogonal to the +Y direction.

As described above, by moving the shaft 45 provided with the handle 46 along the +Z direction and moving the runner 43 with respect to the notch 42, the plurality of arms 6 supporting the screen 2 and the leg portion 9 having the installation base 93 can be simultaneously unfolded and stored.

### Effects of Second Embodiment

The folding screen 1B according to the present embodiment described above has the following effects in addition to the same effects as those of the folding screen 1A according to the first embodiment.

In the support member 3B, the leg portion 9 has the first leg link 91, the second leg link 92, and the installation base 93.

The first leg link 91 has the portion at the end portion 9E1 side rotatably supported by the notch 42. Specifically, the end portion 911 of the first leg link 91 is rotatably supported by the leg support portion 423 of the notch 42.

The second leg link 92 has the portion at the end portion 9E1 side rotatably coupled to the runner 43, and the portion at the end portion 9E2 side rotatably coupled between the end portion 911 as the one end of the first leg link 91 and the end portion 912 as the other end. Specifically, in the second leg link 92, the end portion 922 is rotatably coupled to the leg support portion 433 of the runner 43, and the end portion 921 is rotatably coupled to the coupling portion 913 of the first leg link 91.

The installation base 93 is provided at the end portion 912 of the first leg link 91 and is installed on the installation surface.

According to the configuration, when the state of the support member 3B is changed from the stored state to the unfolded state, the leg portion 9 can be easily unfolded together with the unfolding of the screen 2.

Furthermore, since the number of components forming the leg portion 9 can be reduced, the strength of the leg portion 9 can be increased.

### Modifications of Embodiments

The present disclosure is not limited to each of the above embodiments, but includes modifications, improvements, and the like within a range in which the purpose of the present disclosure can be achieved.

In each of the embodiments, the runner 43 as the second support unit is moved relative to the notch 42 as the first support unit along the +Z direction. However, the present disclosure is not limited thereto, and the notch 42 may be moved relative to the runner 43 along the +Z direction.

In each of the above embodiments, each arm 6 includes the first arm link 61, the second arm link 62, the third arm link 63, the fourth arm link 64, the first arm wire 65, the second arm wire 66, and the holding portion 67. However, the present disclosure is not limited thereto, and the first arm wire 65 and the second arm wire 66 may be omitted as long as the arm links 61 to 64 can be synchronously displaced from the stored state to the unfolded state.

Furthermore, each arm 6 includes two arm links similarly to the leg portion 9 according to the second embodiment. That is, each arm 6 may include the arm body 60 having the one end portion 6E1 rotatably supported by the notch 42 of the support section 41, and a con rod rotatably supported by the runner 43 of the support section 41 and coupled to the arm body 60, and the number of the arm links forming the arm body 60 may be one or an odd number of three or more. When the number of arm links forming the arm body 60 is one, one end of the arm link may be rotatably supported by the notch 42, the holding portion 67 may be provided at the other end of the arm link, one end of the con rod may be rotatably supported by the runner 43, and the other end of the con rod may be rotatably coupled between the one end and the other end of the arm link.

In each of the above embodiments, the moving unit 44 includes the shaft 45 inserted through the notch 42 and coupled to the runner 43, and the handle 46 provided at the side opposite to the runner 43 with respect to the notch 42 in the shaft 45. However, the configuration of the moving unit 44 that moves one of the notch 42 and the runner 43 relative to the other is not limited thereto.

In each of the above embodiments, the intersection angle α between the extension direction of the holding portion 67 and the screen 2 is an acute angle. However, the present disclosure is not limited thereto, and the intersection angle α between the extension direction of the holding portion 67 and the screen 2 may be a right angle or an obtuse angle.

In each of the above embodiments, the first arm link 61 and the second arm link 62 are replaceable. However, the present disclosure is not limited thereto, and only one of the first arm link 61 and the second arm link 62 may be replaceable. Furthermore, in the support members 3A and 3B, the arm 6 itself may be replaceable. Moreover, the arm links 61 to 64 forming the arm 6 may not be replaceable.

In each of the above embodiments, in the movement restriction section 47, the movement of the shaft 45 is restricted by the claw portion 502 of the lock lever 50 being inserted into the first groove portion 451 or the second groove portion 452 of the shaft 45, thereby maintaining the stored state and the unfolded state. However, the present disclosure is not limited thereto, and the stored state and the unfolded state may be maintained by fixing the notch 42 and the runner 43 with a hook.

Alternatively, the shaft 45 may have a claw portion, an inserted portion such as a groove portion or a recess portion into which the claw portion is inserted may be provided in the member covering around the shaft 45 such as the notch 42 and the movement restriction section 47, and the stored state and the unfolded state may be maintained by inserting the claw portion into the inserted portion.

In each of the above embodiments, the movement restriction section 47 has the biasing portion 51 that biases the lock lever 50 in the direction in which the claw portion 502 is closer to the shaft 45. However, the present disclosure is not limited thereto, and for example, in a case where the movement restriction section 47 has a configuration in which the claw portion 502 is inserted into the groove portions 451 and 452 according to the operation of the user or the like, the biasing portion 51 may not be provided.

In each of the above embodiments, the end portion opposite to the end portion supported by the switching mechanism 4 in each arm 6 is located in the +Z direction with respect to the switching mechanism 4 in the unfolded state. However, the present disclosure is not limited thereto, and in a case where the screen 2 bulging in the +Z direction is adopted or the like, the end portion opposite to the end portion supported by the switching mechanism 4 in each arm 6 is not necessarily located in the +Z direction with respect to the switching mechanism 4 in the unfolded state.

In each of the above embodiments, the support members 3A and 3B each includes the four arms 6. However, the present disclosure is not limited thereto, and the support members 3A and 3B each may include three arms 6 or five or more arms 6.

In each of the above embodiments, the support members 3A and 3B include the elastic members EM that couple the leg portions 8 and 9 and the handle 46. However, the present disclosure is not limited thereto, and the support members 3A and 3B may not include the elastic members EM. Furthermore, the configuration for suppressing rattling by biasing the shaft 45 in the -Z direction or the +Z direction is not limited to the elastic member EM, and may be, for example, a biasing member or an elastic member disposed between the notch 42 or the movement restriction section 47 and the handle 46.

In each of the above embodiments, the curtain supported and unfolded by each of the folding support members 3A and 3B is the screen 2 that displays an image corresponding to a projected image light. However, the curtain is not limited thereto, and may be a tarp that blocks light, wind, or rain, or may be a reflective curtain that reflects light.

In each of the above embodiments, the folding screens 1A and 1B each unfolds the screen 2. A projector that projects an image light in the +Z direction may be provided in the runner 43 of each of the folding screens 1A and 1B, and thus a folding image display device that displays an image in the +Z direction by the transmissive screen 2 may be configured.

### Summary of Present Disclosure

The present disclosure will be summarized below as appendices.

### Appendix 1

A folding support member that supports and unfolds a curtain includes a leg portion installed on an installation surface, a plurality of arms that support the curtain, and a support section that supports one end of each of the plurality of arms and one end of the leg portion, and a switching mechanism configured to switch between a stored state in which each of the plurality of arms and the leg portion extend from the support section along a first direction and an unfolded state in which the curtain is unfolded, wherein the unfolded state is a state in which another end of each of the plurality of arms and another end of the leg portion are separated from each other and each of the plurality of arms and the leg portion are unfolded.

According to the configuration, by switching from the stored state to the unfolded state by the switching mechanism, the curtain can be used, and the leg portion can be installed on the installation surface. Accordingly, it is possible to prevent the curtain from coming into contact with the installation surface, and it is not necessary to separately support the folding support member by a jig. Therefore, the installability of the folding support member can be enhanced, and the convenience of the folding support member can be enhanced.

### Appendix 2

In the folding support member according to Appendix 1, the support section has a first support unit and a second support unit, and a moving unit that moves a portion of one of the first support unit and the second support unit closer to and away from a portion of another along the first direction, and each of the plurality of arms has a first arm link having a portion at one end side rotatably supported by the first support unit, a second arm link to which a portion at another end side of the first arm link is rotatably coupled, a third arm link to which a portion at another end side of the second arm link is rotatably coupled, a fourth arm link having a portion at one end side rotatably coupled to the second support unit, and a portion at another end side rotatably coupled between the one end of the first arm link and the other end of the first arm link, and a holding portion provided at another end of the third arm link and holding the curtain.

According to the configuration, it is possible to easily switch between the stored state and the unfolded state by moving a portion of one of the first support unit and the second support unit toward and away from a portion of the other by the moving unit.

In addition, since each of the plurality of arms has the above-described configuration, it is possible to reduce the size of the folding support member in the stored state and to unfold a large curtain in the unfolded state.

Therefore, the convenience of the folding support member can be enhanced.

### Appendix 3

In the folding support member according to Appendix 2, an intersection angle between an extension direction of the holding portion and the curtain in the unfolded state is a right angle or an acute angle at a center side of the curtain.

According to the configuration, the plurality of arms can apply biasing forces in directions away from the center of the curtain to the corner portions of the curtain in the unfolded state. Therefore, the curtain can be unfolded without wrinkles.

### Appendix 4

In the folding support member according to Appendix 2 or 3, at least one arm link of the first arm link and the second arm link is replaceable.

According to the configuration, since at least one of the first arm link and the second arm link forming the arm is replaceable, the length of the arm can be adjusted according to the size of the curtain to be unfolded. That is, by adjusting the lengths of the arms, the curtains having different sizes can be unfolded. Therefore, the convenience of the folding support member can be enhanced.

### Appendix 5

In the folding support member according to any one of Appendices 2 to 4, the moving unit has a shaft extending along the first direction, inserted through a portion of one of the first support unit and the second support unit, and coupled to a portion of another, and a handle provided at a side opposite to the portion of the other with respect to the portion of the one in the shaft.

According to the configuration, by gripping the handle and moving the shaft along the first direction, a portion of one of the first support unit and the second support unit can be moved toward and away from the other. Accordingly, the state of the folding support member can be easily switched between the stored state and the unfolded state. Therefore, the convenience of the folding support member can be enhanced.

### Appendix 6

In the folding support member according to Appendix 5, the shaft is inserted through the first support unit and coupled to the second support unit, and the handle is provided at an end portion opposite to the second support unit with respect to the first support unit in the shaft.

According to the configuration, the handle is disposed in a direction opposite to the first direction in which the plurality of arms extend from the support unit in the stored state with respect to the first support unit. Accordingly, the curtain can be unfolded by pulling the handle in the direction opposite to the first direction. Therefore, since the curtain can be easily unfolded as compared with a case where the handle is located at the second support unit side with respect to the first support unit, the convenience of the folding support member can be enhanced.

### Appendix 7

In the folding support member according to Appendix 6, the shaft has a first groove portion and a second groove portion separated from each other along the first direction, and the switching mechanism includes a movement restriction section inserted into the first groove portion in the stored state and inserted into the second groove portion in the unfolded state to restrict movement of the shaft along the first direction.

According to the configuration, the movement of the shaft can be restricted in each of a case where the state of the folding support member is the stored state and a case where the state is the unfolded state. In other words, it is possible to restrict the plurality of arms and the leg portion from easily moving in each of the stored state and the unfolded state. Therefore, the state of the folding support member can be easily maintained in the stored state and the unfolded state.

### Appendix 8

In the folding support member according to Appendix 7, the movement restriction section has a claw portion configured to be inserted into the first groove portion and the second groove portion, and a biasing portion that biases the claw portion in a direction in which the claw portion is inserted into the shaft.

According to the configuration, the claw portion can be easily inserted into the first groove portion or the second groove portion. Therefore, the state of the folding support member can be easily maintained in the stored state and the unfolded state.

### Appendix 9

In the folding support member according to any one of Appendices 2 to 6, the switching mechanism has a movement restriction section that restricts movement of the portion of the one along the first direction in one state of the stored state and the unfolded state.

According to the configuration, similarly to the above, it is possible to easily maintain the state of the folding support member in the stored state and the unfolded state by the movement restriction section.

### Appendix 10

In the folding support member according to any one of Appendices 2 to 9, the leg portion has a first leg link having a portion at one end side rotatably supported by the first support unit, a second leg link having a portion at one end side rotatably coupled to the second support unit and a portion at another end side rotatably coupled between the one end of the first leg link and the other end of the first leg link, and an installation base provided at the other end of the first leg link and installed on the installation surface.

According to the configuration, when the state of the folding support member is changed from the stored state to the unfolded state, the leg portion can be easily unfolded together with the unfolding of the curtain.

Furthermore, since the number of components forming the leg portion can be reduced, the strength of the leg portion can be increased.

### Appendix 11

In the folding support member according to any one of Appendices 2 to 9, the leg portion has a first leg link having a portion at one end side rotatably supported by the first support unit, a second leg link having a portion at one end side rotatably coupled to a portion at another end side of the first leg link, a third leg link having a portion at one end side rotatably coupled to a portion at another end side of the second leg link, a fourth leg link having a portion at one end side rotatably coupled between the one end of the first leg link and the other end of the first leg link, and a portion at another end side rotatably coupled to the second support unit, and an installation base provided at another end of the third leg link and installed on the installation surface.

According to the configuration, when the state of the folding support member is changed from the stored state to the unfolded state, the leg portion can be easily unfolded together with the unfolding of the curtain.

Furthermore, in the leg portion, the leg links are folded in the stored state, and thus the leg portion can be compactly stored in the stored state even when the longer leg portion is employed. In other words, since the longer leg portion can be adopted, the distance between the unfolded curtain and the installation surface can be increased. Therefore, the curtain can be unfolded in a place apart from the installation surface, and thus the convenience of the folding support member can be enhanced.

### Appendix 12

In the folding support member according to any one of Appendices 1 to 11, the other end of each of the plurality of arms is disposed in the first direction with respect to the switching mechanism in the unfolded state.

According to the configuration, it is possible to prevent the unfolded curtain from interfering with the switching mechanism. Therefore, the curtain can be unfolded without wrinkles.

### Appendix 13

A folding screen includes the folding support member according to any one of Appendices 1 to 12, and a curtain supported by the folding support member, wherein the curtain is a screen that displays an image corresponding to a projected image light.

The folding screen has the same effects as the folding support member described above.

What is claimed is:

1. A folding support member that supports and unfolds a curtain comprising:
a leg portion installed on an installation surface;
a plurality of arms that support the curtain; and
a support section that supports one end of each of the plurality of arms and one end of the leg portion, and a switching mechanism configured to switch between a stored state in which each of the plurality of arms and the leg portion extend from the support section along a first direction and an unfolded state in which the curtain is unfolded, wherein
the unfolded state is a state in which another end of each of the plurality of arms and another end of the leg portion are separated from each other and each of the plurality of arms and the leg portion are unfolded.

2. The folding support member according to claim 1, wherein
the support section has
a first support unit and a second support unit, and
a moving unit that moves a portion of one of the first support unit and the second support unit closer to and away from a portion of another along the first direction, and
each of the plurality of arms has
a first arm link having a portion at one end side rotatably supported by the first support unit,
a second arm link to which a portion at another end side of the first arm link is rotatably coupled,
a third arm link to which a portion at another end side of the second arm link is rotatably coupled,
a fourth arm link having a portion at one end side rotatably coupled to the second support unit, and a portion at another end side rotatably coupled between the one end of the first arm link and the other end of the first arm link, and
a holding portion provided at another end of the third arm link and holding the curtain.

3. The folding support member according to claim 2, wherein
an intersection angle between an extension direction of the holding portion and the curtain in the unfolded state is a right angle or an acute angle at a center side of the curtain.

4. The folding support member according to claim 2, wherein
at least one arm link of the first arm link and the second arm link is replaceable.

5. The folding support member according to claim 2, wherein
the moving unit has
a shaft extending along the first direction, inserted through a portion of one of the first support unit and the second support unit, and coupled to a portion of another, and
a handle provided at a side opposite to the portion of the other with respect to the portion of the one in the shaft.

6. The folding support member according to claim 5, wherein
the shaft is inserted through the first support unit and coupled to the second support unit, and
the handle is provided at an end portion opposite to the second support unit with respect to the first support unit in the shaft.

7. The folding support member according to claim 6, wherein
the shaft has a first groove portion and a second groove portion separated from each other along the first direction, and
the switching mechanism includes a movement restriction section inserted into the first groove portion in the stored state and inserted into the second groove portion in the unfolded state to restrict movement of the shaft along the first direction.

8. The folding support member according to claim 7, wherein
the movement restriction section has
a claw portion configured to be inserted into the first groove portion and the second groove portion, and
a biasing portion that biases the claw portion in a direction in which the claw portion is inserted into the shaft.

9. The folding support member according to claim 2, wherein
the switching mechanism has a movement restriction section that restricts movement of the portion of the one along the first direction in either the stored state or the unfolded state.

10. The folding support member according to claim 2, wherein
the leg portion has
a first leg link having a portion at one end side rotatably supported by the first support unit,
a second leg link having a portion at one end side rotatably coupled to the second support unit and a portion at another end side rotatably coupled between the one end of the first leg link and the other end of the first leg link, and
an installation base provided at the other end of the first leg link and installed on the installation surface.

11. The folding support member according to claim 2, wherein
the leg portion has
a first leg link having a portion at one end side rotatably supported by the first support unit,
a second leg link having a portion at one end side rotatably coupled to a portion at another end side of the first leg link,
a third leg link having a portion at one end side rotatably coupled to a portion at another end side of the second leg link,
a fourth leg link having a portion at one end side rotatably coupled between the one end of the first leg link and the other end of the first leg link, and a portion at another end side rotatably coupled to the second support unit, and
an installation base provided at another end of the third leg link and installed on the installation surface.

12. The folding support member according to claim 1, wherein
the other end of each of the plurality of arms is disposed in the first direction with respect to the switching mechanism in the unfolded state.

13. A folding screen comprising:
the folding support member according to claim 1; and
a curtain supported by the folding support member, wherein
the curtain is a screen that displays an image corresponding to a projected image light.
